(19) United States
(12) Patent Application Publication
(10) Pub. No.: US 2010/0066472 A1
(43) Pub. Date: Mar. 18, 2010

(54) OPTIMISED SOLENOID WINDING

(75) Inventors: Bastien Orlando, Les Pennes Mirabeau (FR); Bernard Viala, Sassenage (FR)

Correspondence Address: OLIFF & BERRIDGE, PLC, P.O. BOX 320850, ALEXANDRIA, VA, 22320-4850, US

(73) Assignees: COMMISSARIAT A L'ENERGIE ATOMIQUE, Paris (FR); STMICROELECTRONICS S.A., Montrouge (FR)

(21) Appl. No.: 12/312,422

(22) PCT Filed: Nov. 30, 2007
(86) PCT No.: PCT/FR2007/001967

§ 371 Date: May 8, 2009

(30) Foreign Application Priority Data
Dec. 1, 2006 (FR) 0610521

(51) Int. Cl. H01F 5/00

(52) U.S. Cl. 335/282

(57) ABSTRACT

The inductive micro-device comprises a rectilinear solenoid winding comprising a plurality of disjointed rectangular turns each having predetermined dimensions. At least one of the dimensions of the turns is variable and is determined individually for each turn according to the position of the turn along the winding and to predetermined magnetic characteristics of the winding, in particular a homogeneous magnetic field and/or an optimum quality factor. Said variable dimension of the turns is chosen from the width, length, thickness, height of turn and the value of the gap between two adjacent turns.

### BACKGROUND OF THE INVENTION

The invention relates to an inductive micro-device comprising a rectilinear solenoid winding comprising a plurality of disjointed rectangular turns each having predetermined dimensions.

The invention applies in particular to all inductive systems, either integrated or not, of the type involving inductors, transformers, magnetic recording heads, actuators, sensors etc. requiring low losses or a very homogeneous magnetic flux density. The invention applies more particularly to integrated micro-inductors.

### STATE OF THE ART

Integrated micro-inductors with different types of winding, for example of the solenoid or spiral type etc., have existed for a large number of years now. In a spiral winding, the turns located at the center of the winding generally contribute more to high-frequency losses than the other turns. These losses are conventionally proportional to the thickness of the turn and to the cube of its width. New forms of spirals have been designed and proposed, but their gains prove to be limited.

A conventional solenoid winding presents the advantage of having a periodic structure, which limits proximity effects naturally. However, at the edges of the solenoid, the proximity effects remain very high. Furthermore, inside the solenoid, the magnetic flux may be fairly inhomogeneous, which may cause problems in the presence of magnetic material.

For example purposes, FIG. 1 illustrates an integrated inductor 1 with a winding 2a in the form of a spiral comprising four magnetic elements 2b, for example in the form of a trapezoid, arranged above winding 2a, as described in particular in the article “Bidirectional ferromagnetic spiral inductors using single deposition” by B. Viala et al. (IEEE Trans. Magnetics, vol. 41, n° 10, pp. 3544-3549, October 2005) and in the article “Dual spiral sandwiched magnetic thin film inductor using Fe—Hf—N soft magnetic films as a magnetic core” by K. H. Kim et al. (Journal of Magnetism and Magnetic Materials 239, 2002, 579-581). This type of inductor 1, i.e. with a planar spiral winding with magnetic planes, is most commonly used in microelectronics, as it is in particular very easy to integrate.

However, the proximity effects in the winding, and in particular at the level of the internal turns, are very high. These effects can moreover be further increased by the presence of a high-permeability magnetic material, in particular as described in the article “Investigation of anomalous losses in thick Cu ferromagnetic spiral inductors” by B. Viala et al. (IEEE Trans. Magnetics, vol. 41, n° 10, pp. 3583-3585, October 2005) and in the article “Analysis of current crowding effects in multiturn spiral inductors” by W. B. Kuhn et al. (IEEE Trans. Microwave Theory and Techniques, vol. 49, n° 1, pp 31-38, January 2001).

To reduce the effect of losses described above, an inductance 3 in the form of a planar spiral 4 with a variable width of turn, as represented in FIG. 2, has been proposed. Reducing the width, in particular of the internal turns of the spiral 4, results in limiting their contributions to losses. However, this also leads to an increase of the width of the external turns in order to keep approximately the same DC resistance (Direct Current (DC)), as described in particular in the article “Investigation of Proximity Effects in Ferromagnetic Inductors with Different Topologies: modeling and solutions” by A-S. Royet et al. (Trans. Of the Magnetic Society of Japan, vol. 5, n° 4, November 2005). However, the magnetic field still remains inhomogeneous, which limits the quality factor of the inductor.

In FIGS. 3a and 3b, another form of inductor 5 in the form of a planar spiral 6a has been proposed, with spiral 6a formed by a plurality of blades 6b, for example three blades 6b in FIG. 3b, to limit the induced current loops, as described in particular in the article “Investigation of Proximity Effects in Ferromagnetic Inductors with Different Topologies: modeling and solutions” by A-S. Royet et al. (Trans. Of the Magnetic Society of Japan, vol. 5, no. 4, November 2005). However, as the conductivity of the winding is high, the current loops are only very slightly attenuated and the quality factor gains are also relatively small.

In FIG. 4, another type of inductor 7 is represented, with a plurality of rectilinear solenoid windings 8 arranged parallel to one another, as described in particular in the article “A Fully Integrated Planar Toroidal Inductor with a Micromachined Nickel-Iron Magnetic Bar” by Chong H. Ahn et al. (IEEE Trans. Components, Packaging and Manufacturing Technology—part A, vol. 17, n° 3, September 1994). In this type of naturally periodic geometry, the proximity effects are lesser, since, for the turns 9 at the heart of the solenoid 8, the magnetic fields created by the neighboring turns are compensated to a great extent.

However, for turns 9 at the edge of solenoid 8, there is not this compensation. Furthermore, inside a turn 9, a proximity effect exists between the bottom and top parts of the turn, and these effects can be further increased in the presence of a magnetic material. The magnetic field is moreover inhomogeneous inside solenoid 8, which may cause problems as far as current strength is concerned when a magnetic core is used.

If areas of the magnetic core see a more intense magnetic field than others, they will in fact be easily saturated and inductor 7 will be very sensitive to the level of the current flowing through winding 8. Furthermore, the parts of the core seeing a very weak magnetic field will be little solicited and will only participate to a small extent in inductance. Consequently, the trade-off between inductance and current strength will be far from being optimal.

Conventionally, as represented in FIGS. 5a to 5c illustrating an open rectilinear solenoid winding 10 respectively in longitudinal cross-section, in top view and in transverse cross-section, solenoid winding 10 conventionally comprises a plurality of disjointed rectangular turns 11 (FIG. 5c), i.e. not adjacent to one another but forming one and the same coil, as represented by the broken lines in FIG. 5a. Turns 11 are each defined by the following geometric parameters: width W_{BOB} (FIG. 5b), length L_{BOB} (FIG. 5b), thickness E_{BOB} (FIG. 5a) and height of turn ISOL (FIG. 5c). The height of turn is called ISOL because it corresponds in particular to the distance between the top part and the bottom part of the winding defining the insulation of the winding.

Winding 10 is also defined by the gap INT between two adjacent turns 11 (FIG. 5a) and by the number of turns N of winding 10. In the case where winding 10 is associated with a magnetic core 12, the following geometric parameters also have to be considered: thickness E_{MAG} (FIG. 5a), length L_{MAG} and width W_{MAG} (FIG. 5b) of magnetic core 12.

However, although this conventional configuration of rectilinear solenoid winding 10 is easy to implement, the magnetic field remains non-homogeneous.

### OBJECT OF THE INVENTION

The object of the invention is to remedy all the shortcomings set out above and to provide an inductive micro-device having a winding of solenoid type that is easy to implement, that is able to be used for any type of application and that enables proximity effects to be reduced, high-frequency losses to be reduced and a homogeneous magnetic flux to be obtained all along the solenoid winding.

According to the invention, this object is achieved by the appended claims, and more particularly by the fact that one of the dimensions of the turns is variable and determined individually for each turn according to its position along the winding and to predetermined magnetic characteristics of the winding.

### BRIEF DESCRIPTION OF THE DRAWINGS

Other advantages and features will become more clearly apparent from the following description of particular embodiments of the invention given for non-restrictive example purposes only and represented in the appended drawings in which:

FIG. 1 schematically represents a particular embodiment of an inductor with a planar spiral winding, with magnetic planes, according to the prior art.

FIGS. 2, 3a and 3b schematically represent other types of inductors with a planar spiral winding according to the prior art.

FIG. 4 schematically represents a particular embodiment of an inductor with a rectilinear solenoid winding according to the prior art.

FIGS. 5a to 5c respectively represent a front view in longitudinal cross-section, a top view and a side view in transverse cross-section of a particular embodiment of a rectilinear solenoid winding with a rectangular transverse cross-section according to the prior art.

FIGS. 6a and 6b respectively represent a front view in longitudinal cross-section and a top view of a particular embodiment of a rectilinear solenoid winding with a rectangular transverse cross-section according to the invention.

FIGS. 7a to 7c very schematically represent alternative embodiments of the solenoid winding according to FIGS. 6a and 6b.

FIG. 8 is a graph giving the standard deviation of the magnetic field along the longitudinal axis of the solenoid winding, the width of the turns of which varies according to a geometric progression according to the ratio of this geometric progression.

FIGS. 9a and 9b are graphs illustrating, in top view, the form of the winding of certain points of the graph according to FIG. 8.

FIG. 10 is a graph representing the standardized quality factor of a winding, the width of the turns and the length of the turns whereof both vary according to a geometric progression of respective ratios QW and QL according to QW for different values of QL.

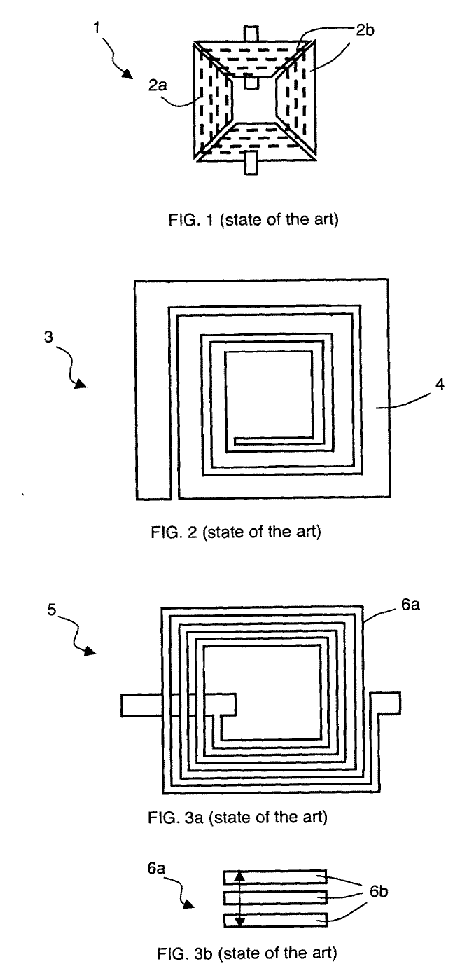

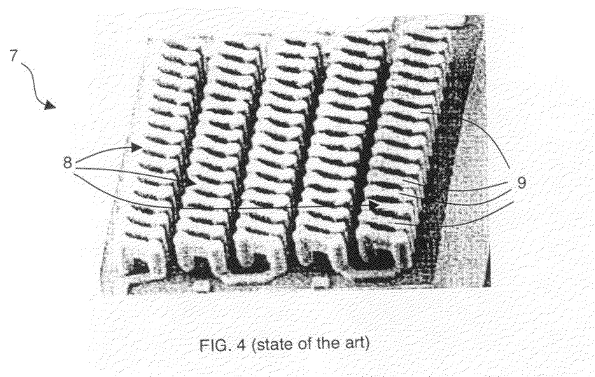

### DESCRIPTION OF PARTICULAR EMBODIMENTS

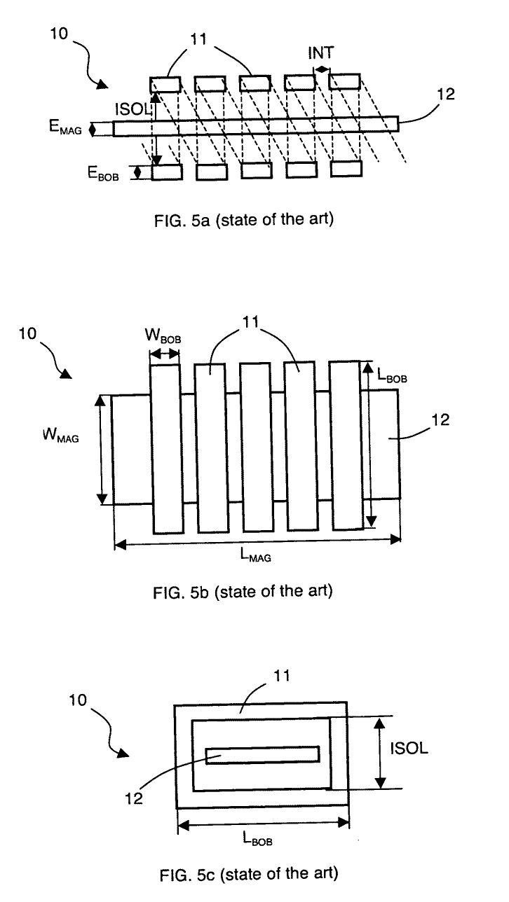

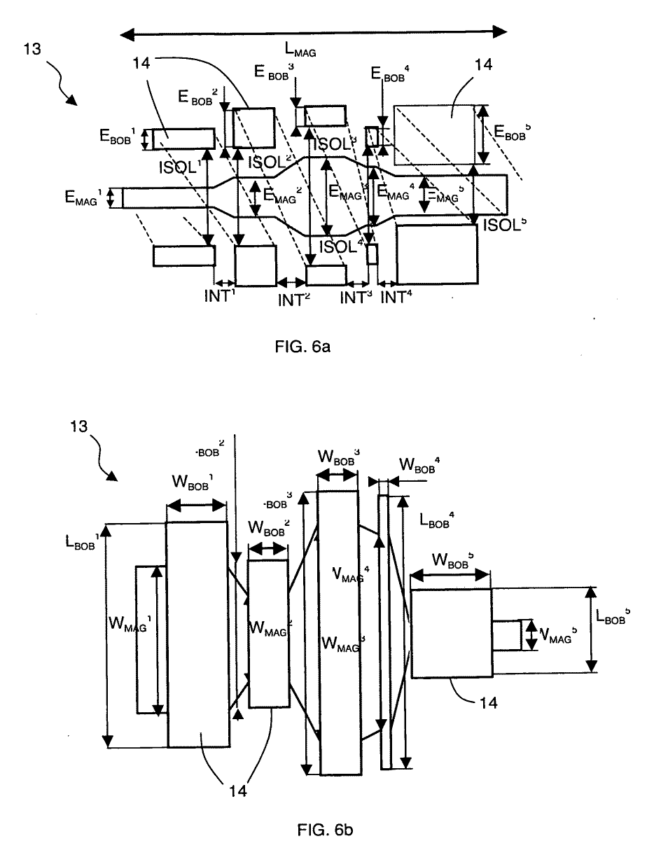

With reference to FIGS. 6a to 10, the inductive micro-device comprises a solenoid winding and more precisely a solenoid micro-winding. The rectilinear solenoid winding 13 with rectangular transverse cross-section (FIG. 6a) according to the invention preferably comprises a plurality of disjointed and rectangular turns 14. Turns 14 of winding 13 are rectangular, i.e. each turn presents, seen from the side, a substantially rectangular shape defining two top and bottom horizontal branches and two lateral branches joining the top and bottom branches (FIG. 5c). Two successive turns 14 are non-adjacent and all the turns 14 of winding 13 form one and the same coil, as represented by broken lines in FIG. 6a. Each turn 14 more particularly presents a rectangular transverse cross-section (FIG. 6a) and each turn 14 of winding 13 is then defined as before by predetermined dimensions, i.e. width W_{BOB}, length L_{BOB}, thickness E_{BOB} and height of turn ISOL.

The general principle of the invention is illustrated in FIGS. 6a and 6b. Rectilinear solenoid winding 13, in FIGS. 6a and 6b, comprises five rectangular disjointed turns 14 respectively having a width W_{BOB}¹ to W_{BOB}⁵ (FIG. 6b), a length L_{BOB}¹ to L_{BOB}⁵ (FIG. 6b), a thickness E_{BOB}¹ to E_{BOB}⁵ (FIG. 6a) and a height of turn ISOL¹ to ISOL⁵ (FIG. 6a), all of different values. Winding 13 also presents a different gap INT between two adjacent and successive turns 14, i.e. INT¹ to INT⁴. Winding 13 is associated with a magnetic core 15 in the form of a bar having different sections associated with each turn 14 of solenoid winding 13.

In FIGS. 6a and 6b, the dimensions of each turn 14 vary according to the position of turn 14 along solenoid winding 13 and are determined individually for each turn 14, in particular according to predetermined magnetic characteristics of winding 13, for example if a homogeneous magnetic field is sought for or if an optimum quality factor has to be obtained.

In FIGS. 6a and 6b, widths W_{BOB}¹ to W_{BOB}⁵ are all different from one another, with width W_{BOB}⁵ of the fifth turn larger than width W_{BOB}¹ of the first turn, itself larger than width W_{BOB}³ of the third turn, itself larger than width W_{BOB}² of the second turn, itself larger than width W_{BOB}⁴ of the fourth turn. The lengths are also all different from one another, with L_{BOB}³ larger than L_{BOB}⁴, itself larger than L_{BOB}¹, itself larger than L_{BOB}², itself larger than L_{BOB}⁵. The thicknesses are also different from one another, with E_{BOB}⁵ larger than E_{BOB}², itself larger than E_{BOB}³, itself larger than E_{BOB}¹, itself larger than E_{BOB}⁴. Finally, the height of turn is also different for each turn, with ISOL³ larger than ISOL¹, itself larger than ISOL², itself larger than ISOL⁴, itself larger than ISOL⁵.

In the same way, magnetic core 15 therefore comprises five different sections each associated with a turn 14 of winding 13. The sections are defined by their width W_{MAG}, their length L_{MAG} and their thickness E_{MAG}. The sections are for example substantially flat and are joined by section transition zones which are for example substantially trapezoid. In FIGS. 6a and 6b, the dimensions of the sections of core 15 vary along winding 13, with for example thickness E_{MAG}³ of the third section larger than thickness E_{MAG}⁴ of the fourth section, itself larger than thickness E_{MAG}⁵ of the fifth section, itself larger than thickness E_{MAG}² of the second section, itself larger than thickness E_{MAG}¹ of the first section (FIG. 6a). In the same way (FIG. 6b), width W_{MAG}³ of the third section is larger than width W_{MAG}⁴ of the fourth section, itself larger than width W_{MAG}¹ of the first section, itself larger than width W_{MAG}² of the second section, itself larger than width W_{MAG}⁵ of the fifth section.

Variation of the dimensions of magnetic core 15 associated with solenoid winding 13 is determined according to the dimensions of associated turns 14 or independently according to the position of the sections of magnetic core 15 along solenoid winding 13 and according to the magnetic characteristics required for solenoid winding 13.

This optimization of the dimensions of each turn 14 of winding 13 and the dimensions of each section of associated magnetic core 15 therefore has the purpose of improving not only the operation of solenoid winding 13 itself, but also of improving the performances of the different inductive systems incorporating such a solenoid winding 13.

Solenoid winding 13 according to the invention thereby enables a maximum quality factor or a substantially homogeneous magnetic field to be obtained, in particular by reducing the proximity effects, and thereby proposes a generic design solution for any type of inductive component with or without a magnetic core.

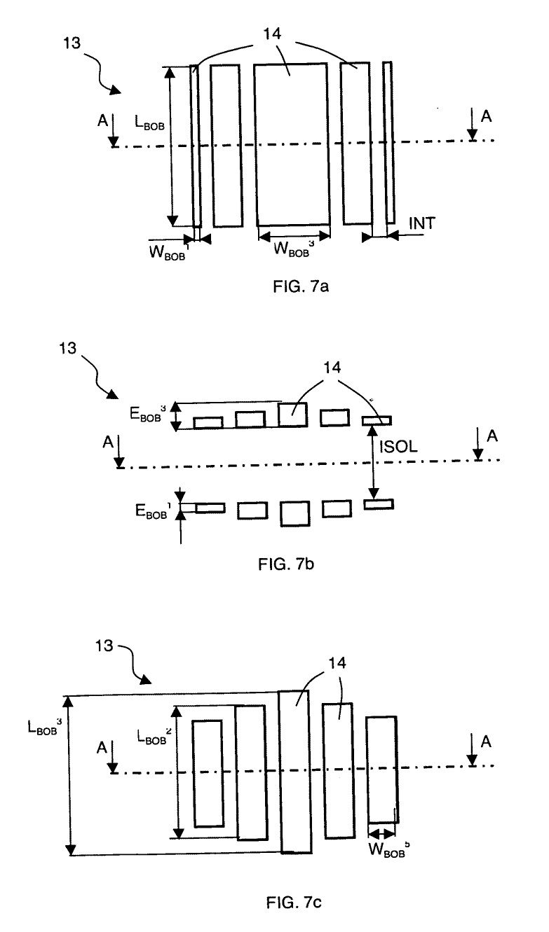

In the alternative embodiments represented in FIGS. 7a to 7c, the solenoid winding is represented very schematically. Solenoid winding 13 comprises five disjointed rectangular turns 14 having dimensions varying for example gradually and preferably symmetrically along winding 13. In FIGS. 7a to 7c, the turns being oriented perpendicularly to the longitudinal reference axis AA of winding 13, the dimensions of turns 14 vary symmetrically with respect to the central turn of winding 13. Such a configuration in particular enables the magnetic field to be more homogeneous at the level of the ends of winding 13.

In the particular embodiment represented in FIG. 7a, solenoid winding 13 comprises five turns 14 of the same length L_{BOB} and preferably of identical thickness E_{BOB}, in particular on account of the technological constraints involved. It is therefore width W_{BOB} of turns 14 that varies along solenoid winding 13 along reference axis AA, with width W_{BOB}³ of central turn 14 larger than the width of the other turns 14, in particular according to the position of turn 14 and according to the magnetic characteristics required for solenoid winding 13.

In FIG. 7b, the alternative embodiment of solenoid winding 13 differs from solenoid winding 13 represented in FIG. 7a by the variable predetermined dimension of turns 14. In FIG. 7b, it is thickness E_{BOB} of turns 14 that is variable, preferably symmetrically, with thickness E_{BOB}³ of central turn 14 larger than the thickness of the other turns 14, in particular according to the position of turn 14 and to the magnetic characteristics required for winding 13. Length L_{BOB} and width W_{BOB} of turns 14 are then preferably identical for all turns 14 of winding 13.

In FIG. 7c, the alternative embodiment of solenoid winding 13 differs from solenoid windings 13 represented in FIGS. 7a and 7b by the predetermined dimension which varies along the winding. In FIG. 7c, it is length L_{BOB} of turns 14 that varies, preferably symmetrically, with length L_{BOB}³ of central turn 14 larger than the length of the other turns 14, in particular according to the position of turn 14 and the magnetic characteristics required for winding 13. Width W_{BOB} and thickness E_{BOB} of turns 14 are then preferably identical for all the turns 14 of winding 13.

Furthermore, in the alternative embodiments represented in FIGS. 7a to 7c, the value of gap INT between two adjacent turns 14 of winding 13 is constant (FIG. 7a) and height of turn ISOL is also constant for all the turns 14 of winding 13 (FIG. 7b). In the alternative embodiments represented in FIGS. 6a and 6b, the values of gap INT and of height of turn ISOL can vary independently along solenoid winding 13 according to the position of turns 14 and the magnetic characteristics required for winding 13.

Furthermore, in the alternative embodiments represented in FIGS. 7a to 7c, winding 13 can be associated possibly with a magnetic core (not shown) having predetermined dimensions that are also able to vary as described above in advantageously symmetrical manner.

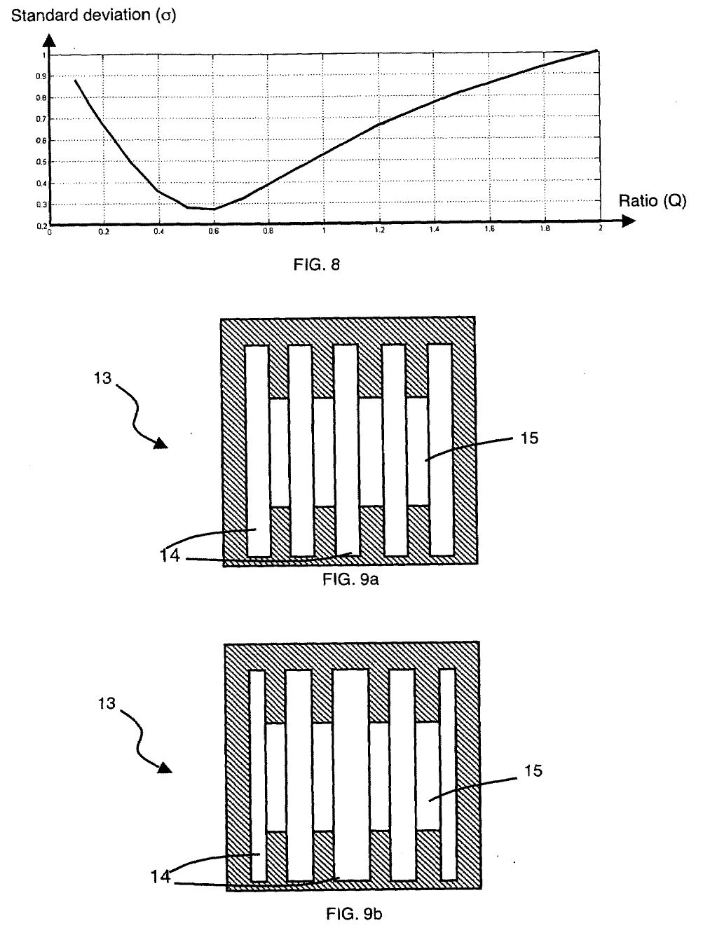

Dimensioning and calculation of the dimensions of each turn of the winding will be described in greater detail with regard to FIGS. 8 to 10. In general manner, the number of geometric parameters to be taken into account for calculation is very large. For each of the N turns noted i and for the associated magnetic core, W_{BOB}ⁱ, L_{BOB}ⁱ, E_{BOB}ⁱ, ISOLⁱ, E_{MAG}ⁱ, and W_{MAG}ⁱ have to be taken into account, to which N−1 gaps between turns INT and the length of magnetic core L_{MAC} have to be added, which adds up to a total of 6N+(N−1)+2=7N+1 parameters (FIGS. 6a and 6b).

In general manner, to simplify calculations, E_{MAG}, W_{MAG} (in the case where the winding is associated with a magnetic core), ISOL, INT and E_{BOB} will be considered to be constant. The optimum trade-off for determining the shape of the turns depends on complex phenomena, in particular on induced currents, capacitive effects, non-linearity and non-homogeneity of the magnetic material forming the magnetic core if applicable, and on the targeted work frequency. It is therefore necessary to have recourse to optimization algorithms, possibly coupled with analytical or numerical design models.

In a first example of two-dimensional dimensioning of a solenoid winding according to the invention, to optimize in particular the trade-off between inductance and saturation current, taking as hypothesis a symmetrical solenoid winding with five turns, without a magnetic core, produced using planar technology, the following geometric parameters are to be taken into account:

W_{BOB}with i={1,2,3}, with by symmetry W_{BOB}¹=W_{BOB}⁵ and W_{BOB}²=W_{BOB}⁴.

INT, E_{BOB} and ISOL are fixed by technological constraints, for example, at respectively 10 μm, 5 μm and 40 μm.

The length of a turn L_{BOB} does not play any part in two-dimensional dimensioning

There is therefore a total of three independent geometric parameters, i.e. W_{BOB}¹, W_{BOB}² and W_{BOB}³. These geometric parameters are moreover subjected to constraints linked to the dimensions of the winding. Considering, in this first particular calculation example, that widths W_{BOB}ⁱ follow a first-term geometric progression W_{BOB}³ corresponding to the width of the central turn, and of ratio Q, i.e. W_{BOB}²=Q×W_{BOB}³ and W_{BOB}¹=Q²×W_{BOB}³, only Q therefore remains to be determined, as W_{BOB}³ is determined according to the predefined maximum length L_{MAX}=100 μm of the winding, with the formula:

$${W}_{BOB}^{3} = \frac{{L}_{MAX} - 5 \cdot INT}{1 + 2 \cdot ( Q + {Q}^{2} )}$$

The standard deviation σ of the magnetic field inside the space of height E_{MAG}=5 μm and length L_{MAX}, in the heart of the solenoid and corresponding to the space occupied by a magnetic core if present, is calculated for example from Biot and Savart's law, according to the following equation:

$$σ = \sqrt{\begin{matrix}\frac{1}{{L}_{MAX} \cdot {E}_{MAG}} {\int }_{- {L}_{MAX} / 2}^{{L}_{MAX} / 2} {\int }_{- {E}_{MAG} / 2}^{{E}_{MAG} / 2} \\ {( {B}_{x} - ( \frac{1}{{L}_{MAX} \cdot {E}_{MAG}} {\int }_{- {L}_{MAX} / 2}^{{L}_{MAX} / 2} {\int }_{- {E}_{MAG} / 2}^{{E}_{MAG} / 2} {B}_{x} \cdot d y d x ) )}^{2} \cdot d y \cdot d x\end{matrix}}$$

The above calculations then enable the influence of ratio Q on the magnetic flux homogeneity to be highlighted. As represented on the graph of FIG. 8 illustrating the mean standard deviation a of the magnetic field component along the axis of the solenoid winding versus the ratio Q, it is apparent that the magnetic field is twice as homogeneous for Q=0.6, as illustrated by winding 13 represented schematically in FIG. 9b with variable widths of turns 14, as for Q=1, as illustrated by winding 13 represented schematically in FIG. 9a with identical turns 14 all along winding 13. The curve plot in fact reaches its minimum at Q=0.6 with a standard deviation value of about 0.26, whereas at Q=1 the standard deviation a is about 0.52. It results from the graph of FIG. 8 that it is more advantageous to use a winding with variable widths (FIGS. 9a and 9b), more particularly a symmetrical rectilinear winding, the width of turns whereof increases from the edge of the rectilinear winding to the center, for example with a geometric progression of ratio 0.6.

In a second particular example of dimensioning of a solenoid winding according to the invention, it is possible to perform three-dimensional dimensioning for optimization of the quality factor. Still considering a symmetrical solenoid winding with five turns, without a magnetic core, made using planar technology and which has to fit in a square of predetermined size L_{MAX}=200 μm, the following geometric parameters are to be taken into account:

W_{BOB}ⁱ with i={1, 2, 3}, with by symmetry W_{BOB}¹=W_{BOB}⁵ and W_{BOB}²=W_{BOB}⁴.

Widths W_{BOB}follow a geometric progression of ratio QW and of first term W_{BOB}³, preferably calculated as in the previous example.

L_{BOB}with i={1, 2, 3}, with by symmetry L_{BOB}¹=L_{BOB}⁵ and L_{BOB}²=L_{BOB}⁴.

Lengths L_{BOB}follow a geometric progression of ratio QL and of first term L_{BOB}³⁼L_{MAX}.

INT is fixed at 10 μm.

E_{BOB} is fixed at 5 μm, so as to limit skin effects.

ISOL is fixed at 40 μm.

A combination of two parameters, i.e. QW and QL, therefore has to be optimized this time. A quick method for calculating the quality factor is preferably used. In particular Kuhn's method, as described in the article “Analysis of current crowding effects in multiturn spiral inductors” by W. B. Kuhn et al. (IEEE Trans. Microwave Theory and Techniques, vol. 49, n° 1, pp. 31-38, January 2001), enables losses by proximity effects to be calculated. The inductive field can be calculated by Biot and Savart's law. The losses by skin effect can be calculated using Press's two-dimensional approach, as described in particular in his article “Resistance and reactance of massed rectangular conductor” (Phys. Review, vol. VIII, n° 4, p. 417, 1916), the capacitive effects being ignored and the inductance being calculated according to the numerical calculation of the magnetic flux.

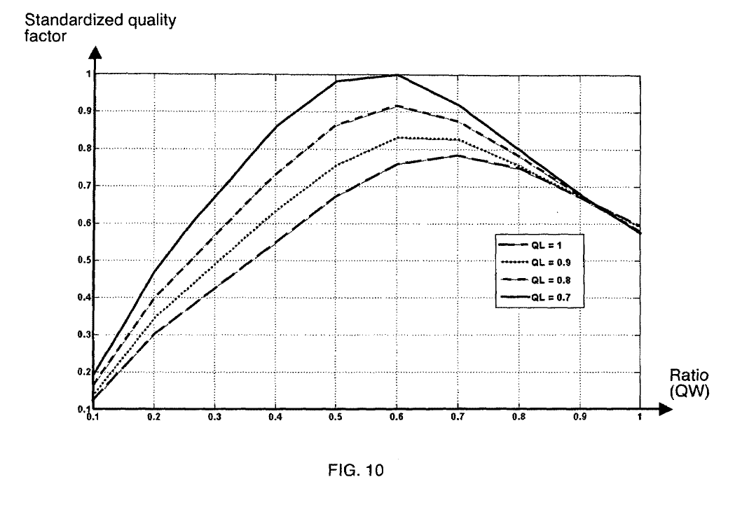

It is then possible to calculate an approximate value of the quality factor, which can then be used for determining the optimized dimensions of the winding turns. As represented on the graph of FIG. 10 representing the standardized quality factor versus the ratio QW, for four different ratio values QL, i.e. QL=1 (line with long dashes), QL=0.9 (line with a succession of dots), QL=0.8 (line with short dashes) and QL=0.7 (unbroken line), a significant gain is observed compared with the initial structure with QW=1 and QL=1, i.e. a winding with turns of the same size all along the solenoid, for a typical resistance of 2μΩ.cm corresponding to the electro-plated copper constituting winding 13.

Indeed, on reading FIG. 10, the best quality factor, that is to say the closest to 1, is obtained for a ratio value QL of 0.7 and for a ratio value QW of 0.6, i.e. corresponding to a symmetrical rectilinear solenoid winding having turns which progress from the ends to the center, in width according to a geometric progression of ratio 0.6 and in length according to a geometric progression of ratio 0.7.

In another example of dimensioning of a solenoid winding 13 according to the invention, an arithmetic progression can be used to characterize the variation of the dimensions of the turns.

Such a solenoid winding as described above, with optimized shape and dimensions of turns by means of the above calculations, therefore enables the best possible magnetic flux distribution to be obtained by optimizing each section of the winding individually according to the required result. It also enables a maximum quality factor and/or a homogeneous magnetic field to be obtained and enables the performances of inductive systems using such a solenoid winding to be significantly improved.

The solenoid winding according to the invention applies more particularly, without frequency or power limitation, to all inductive systems equipped with a solenoid winding with or without a magnetic core, i.e.:

inductors and transformers,

magnetic recording heads for data storage,

inductive sensors, such as “fluxgates” or “permeameters”,

inductive motors and actuators,

field-generating coils.

For example, to produce a permeameter, such a solenoid winding presents the twofold advantage of generating more homogeneous fields and of being less sensitive to proximity effects. Such a winding therefore enables finer measurements of the response of magnetic materials according to the frequency and the magnetic field by the disturbance method.

To achieve such a solenoid winding, technologies used for producing microsystems can be used, in the case where thickness E_{BOB} of the turns and height of turn ISOL are constant along the winding. For example, a large number of manufacturing methods based on techniques for producing integrated magnetic recording heads are possible. Slightly more complex technologies can be implemented in the case where thickness E_{BOB} and height of turn ISOL are variable.

An example of a method for producing a solenoid winding using a “microsystems” technology can comprise the following steps. A first deposition of a conducting material is performed to form the bottom part of the winding, for example by a damascene electrolysis method. Then a first insulating material is deposited.

One or more depositions of magnetic materials (and non-magnetic materials in the case of producing a laminated core) are then made for formation of a magnetic core. Then one or more lithography and etching steps of the core are performed.

A second deposition of insulating material is then performed, and lithography and etching steps of vias in the two insulator layers are performed to be able to close the winding turns. Finally, a second deposition of conducting material is performed to form the top part of the winding.

Such a production method of the “microsystems” type in particular enables a solenoid winding to be obtained quickly and easily with a great degree of freedom as to the choice of the dimensions of the turns, in particular length L_{BOB}, width W_{BOB}, and spacing INT between turns, which is much more difficult to achieve with a micromechanics method, i.e. a method based on winding a wire.

The invention is not limited to the different embodiments described above. The solenoid winding according to the invention can comprise any number of turns, provided that they present at least one variable dimension along the winding, according to the position of the turn along the winding and the magnetic constraints required of the winding.

In general manner, whatever the variation of the dimensions of the turns, the turns with the largest dimensions should advantageously be placed at the center of the winding.

Other examples of dimensioning and calculation of the optimal form of the solenoid winding can take additional production constraints into account. The bottom part of the solenoid winding can for example not have the same thickness as the top part and the solenoid winding can for example not be symmetrical. In these cases, the number of parameters to be taken into account will be superior. The same will be true of the magnetic core at the heart of the solenoid is not centered with respect to the latter.

With reference to the first dimensioning example (FIGS. 8, 9a, 9b), the DC resistance (direct current (DC)) variation from one turn to the other can be taken into account for example by fixing a maximum resistance not to be exceeded or by optimizing the structure by minimizing the product of the standard deviation by the direct current (low frequency).

In other dimensioning examples (not shown), optimization can be performed with less constant preset dimensions. More complex optimization algorithms can then be used, such as genetic algorithms, with for example the Matlab (registered trademark) or Optimetrics (registered trademark) modeling and simulation software, which provide a wide range of constrained or non-constrained optimization methods.

In a more general case, it is possible to use numerical computing software using for example the finite-elements method to calculate the parameters to be optimized more precisely.

1-11. (canceled)

12. An inductive micro-device comprising a rectilinear solenoid winding comprising a plurality of disjointed rectangular turns, each turn having predetermined dimensions, at least one of the dimensions of the turns is variable and determined individually for each turn according to a position of the turn along the winding and to predetermined magnetic characteristics of the winding.

13. The micro-device according to claim 12, wherein said variable dimension of the turns is larger at the center of the winding than at the ends of the winding.

14. The micro-device according to claim 12, wherein said variable dimension of the turns varies symmetrically with respect to the center of the winding.

15. The micro-device according to claim 12, wherein said variable dimension of the turns is chosen from the width, length, thickness, height of turn and gap between two turns.

16. The micro-device according to claim 12, wherein the value of the gap between two adjacent turns of the winding is constant.

17. The micro-device according to claim 12, wherein the value of the gap between two adjacent turns of the winding is variable.

18. The micro-device according to claim 12, wherein it surrounds a magnetic core in the form of a bar having at least one variable predetermined dimension along the winding.

19. The micro-device according to claim 18, wherein said variable dimension of the magnetic core is chosen from the width, length and thickness of the magnetic core.

20. The micro-device according to claim 19, wherein the thickness of the magnetic core is constant along the winding.

21. The micro-device according to claim 12, wherein said variable pre-determined dimensions vary gradually along the solenoid winding.

22. The micro-device according to claim 12, wherein said variable pre-determined dimensions follow a geometric progression.
